(19) United States
(12) Patent Application Publication
(10) Pub. No.: US 2005/0187937 A1
(43) Pub. Date: Aug. 25, 2005

(54) Computer program product, device system, and method for providing document view

(75) Inventors: Shigehisa Kawabe, Yokohama-shi (JP); Kei Ohtsu, Yokohama-shi (JP); Yu Kuratake, Yokohama-shi (JP); Akira Suzuki, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 10/913,387

(22) Filed: Aug. 9, 2004

(30) Foreign Application Priority Data
Feb. 25, 2004 (JP) 2004-050311

(51) Int. Cl. G06F 7/00

(52) U.S. Cl. 707/9

(57) ABSTRACT

A device for providing view information of electronic documents existing on a network. The device comprises an access right information collector unit for collecting, from each document server existing on a network, access right information indicating an access right given to each user for each electronic document stored in the document server and for constructing an access right database, and a view provider unit for creating, in response to a request from a user, view information in which a group of electronic documents for which an access right is given to the user is indicated classified based on the type of the access right referring to the access right database and for providing the view information to the user.

### BACKGROUND OF THE INVENTION

1. Field of the Invention

The present invention relates to a technique for providing information regarding electronic documents existing in various locations on a network such as the Internet.

2. Description of the Related Art

Recently, distribution of electronic documents via a data communication network such as the Internet has become more and more popular. Distribution of electronic documents includes various forms, such as, for example, one-way retrieve of document(s) from an information provider to a customer and bidirectional exchange or sharing of document(s) within a group. Various software and systems are available for document distribution of these various forms and there are now service providers who provide a space for document distribution on a data communication network.

For example, a lot of groupware for promoting collaboration among plural users also includes a function for a document sharing service. In this type of document sharing service, a directory for each user is created on a document delivery server and access rights are set such that only the user of the directory can read the documents in the directory. By the document creator placing the document in directories, among directories in the document delivery server, of users who are allowed to read the document, it is possible to allow only permitted users to read the document.

This configuration is for document sharing within a group. There are also known services for providing electronic documents in a one-way manner in various forms from information providers such as a publisher and newspaper publishers. In order to reduce the cost required for accessing document distribution services of various companies, service provider exist who provide a service which allows for a collective search among documents of various companies.

For example, Japanese Patent Laid-Open Publication No. 2001-273300 discloses a server in which a database is formed by collecting metadata (for example, bibliography and summary) of papers from plural electronic paper distribution companies, a search service using the metadata is provided to users, and reference information to the searched paper is provided. This server also collects information such as a customer ID, a subscribed magazine ID, and contractual coverage and stores these items of information in a subscription master file for control such that permission of access by the user to the searched paper is determined referring to the subscription master, and reference information of a document to which access is not permitted is not provided to the user.

Japanese Patent Laid-Open Publication No. 2002-149468 discloses a server which creates a virtual table called a “view” by integrating plural tables for databases of different administrator organizations. This server collects information about access rights of users to each of the tables within each of the databases and permits or limits access of the user to the virtual table based on the access right information.

In a method for placing a document file in the directory of a user who is permitted to read the document, there is a problem in that when a document is to be published to many people, there is significant cost involved. In addition, in this method, the documents which are permitted to be read by the user are arranged in one directory (that is, not in the structuralized directories), and when there are many documents, significant cost is required for the user to find a document of interest. Moreover, in this method, because the document file itself is placed in the server administering the directories, when the server is administered by a person other than the owner of the document, there is a possibility of leaking out the contents of the documents to the administrator.

In the method disclosed in Japanese Patent Laid-Open Publication No. 2001-273300, on the other hand, the server collects information of access rights from a computer of the individual information provider, and therefore, for the information provider, there is no complexity of placing the documents into the folder of each reader, etc. In addition, because the server only administers the metadata of papers, the possibility of leaking out information of the paper itself to the administrator of the server is decreased. However, the search result provided by the server to the user is displayed in such a manner that, for documents for which access by the user is permitted, the name of the paper is displayed along with a reference, and for documents for which access by the user is not permitted, the name of the paper only is displayed without a reference. In this displayed result, the names of searched documents are simply listed, and thus, when the number of documents becomes large, it is difficult to find a desired document.

Although Japanese Patent Laid-Open Publication No. 2002-149468 discloses a server which collects, from each information providing device, information of access rights to various information, the field of this reference is completely different from the field of sharing or distribution of documents.

### SUMMARY OF THE INVENTION

The present invention advantageously provides a technique for presenting information of a group of electronic documents stored in various locations on a network in a form which allows the user to easily find a document from the viewpoint of access rights.

According to one aspect of the present invention, there is provided a device having an access right information collector unit for collecting access right information indicating access rights given to each user regarding each of electronic documents stored in each of document servers which exist on a network and for constructing an access right database, and a view provider unit for creating, in response to a request by a user, view information in which a group of electronic documents, for which an access right is given to the user, is classified and indicated according to the type of access right, referring to the access right database and for providing the view information to the user.

According to another aspect of the present invention, it is preferable that, in the device, the view provider unit creates view information indicating a folder structure in which, for each folder for each type of access right, electronic documents corresponding to the type of access right given to the requesting user are placed.

According to another aspect of the present invention, it is preferable that, in the device, plural types of access right exist for each of plural viewpoints, the view provider unit creates a hierarchical folder structure having a tree form by placing a group of folders of a type of access right regarding the same viewpoint in one hierarchy level and placing the hierarchy level of each viewpoint according to a predetermined order defined among the plural viewpoints, and creates a folder structure in which electronic documents are placed in a deepest folder in the folder structure, the electronic documents satisfying all types of access right corresponding to the folder and the ancestor folders.

The “viewpoints” regarding types of access right in this structure include, for example, viewpoints of the target user to which the access right is given (in this viewpoint, the access right is classified, for example, into access rights given to an individual user and access rights given to a group to which the user belongs) and viewpoints of operations permitted for the user (in this viewpoint, the access right is classified, for example, into access rights which permit the user to utilize a read operation and access rights which permit the user to utilize write operation). Another example viewpoint includes a viewpoint of date/time or period in which the access rights are set (in this viewpoint, the access right is classified, for example, into access rights regarding day and time or day of the week regarding, for example, a deadline of payment or the like such as the user being permitted to write until a certain day in a certain month).

### BRIEF DESCRIPTION OF THE DRAWINGS

Preferred embodiments of the present invention will be described in detail based on the following figures, wherein:

FIG. 1 is a diagram showing an overall structure of a system for document distribution according to an embodiment of the present invention;

FIG. 2 is a diagram showing a detailed structure of a document server;

FIG. 3 is a diagram showing an example of data content in an access control list;

FIG. 4 is a diagram showing a detailed structure of a crawler server;

FIG. 5 is a diagram showing an example of data content stored in a metadata database;

FIG. 6 is a diagram showing an example of data content stored in an access right database;

FIG. 7 is a diagram showing an example of data content stored in a user database;

FIG. 8 is a diagram showing a process procedure of a view creator unit;

FIG. 9 is a diagram showing an example of a folder structure which is hierarchical based on a type of access right and which is created by the view creator unit;

FIG. 10 is a diagram showing an example of a document property table stored in a search information storage unit;

FIG. 11 is a diagram showing a process procedure of a view creator unit in an alternative embodiment of the present invention; and

FIG. 12 is a diagram showing an example of a folder structure created by a view creator unit in an alternative embodiment of the present invention.

### DESCRIPTION OF PREFERRED EMBODIMENTS

Embodiments of the present invention will now be described referring to the drawings.

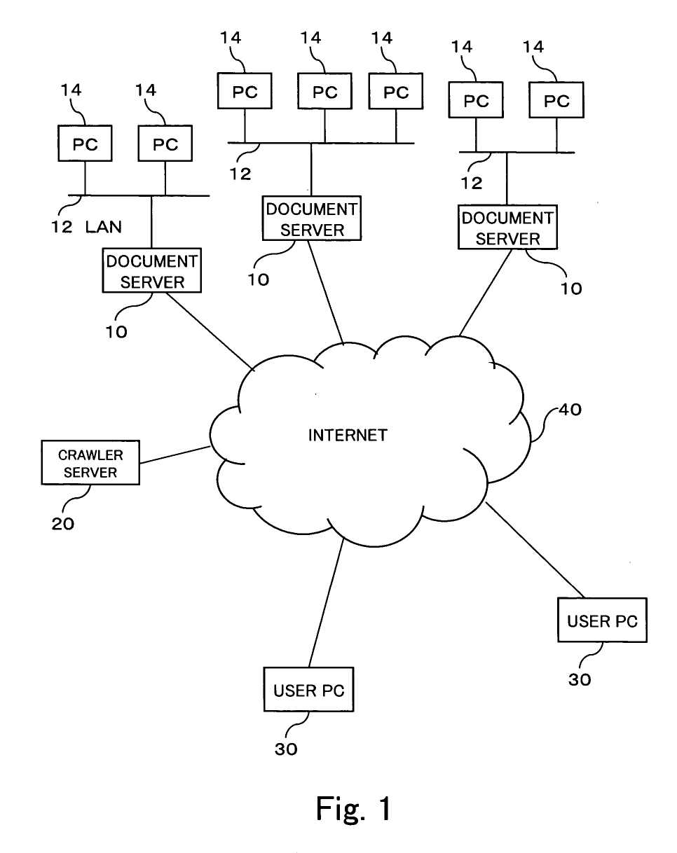

FIG. 1 is a diagram showing an overall structure of a document distribution system to which the present invention can be applied.

In this system, a document server 10 is a server for providing an electronic document to each user via the Internet 40 or LAN (Local Area Network) 12. In a typical structure, the document server 10 is a file server provided by a company or an organization to allow sharing of electronic documents with other companies or organizations. The document server 10 accepts instructions for reading or writing an electronic document file from a computer device (PC) of each user connected to the LAN 12 within the company or organization or from a user PC 30 on the Internet 40. The document server 10 stores a group of files of electronic documents to be provided, manages the read and write operations of the electronic documents by the users, and authenticates the user regarding these operations.

A crawler server 20 collects information on a group of electronic documents administered by each document server 10 and provides a document search service to the users based on the collected information. A typical example of a crawler server 20 is a server of a search site existing on the Internet 40. A user who wishes to perform an operation such as reading or writing to the electronic document accesses the crawler server 20 from the user PC 30 on the Internet 40, obtains information for accessing (for example, information indicating storage location of the electronic documents) regarding a group of electronic documents for which access by the user is permitted, accesses the document server 10 which stores the electronic document using the information for accessing, and applies an operation to the electronic documents.

In the present embodiment, in such a system framework, the crawler server 20 creates and provides a “view” in response to a request by the user, the view including a group of electronic documents for which access by the user is permitted and arranged in a structure according to the type of access right regarding the documents. A detailed structure for realizing this system will now be described.

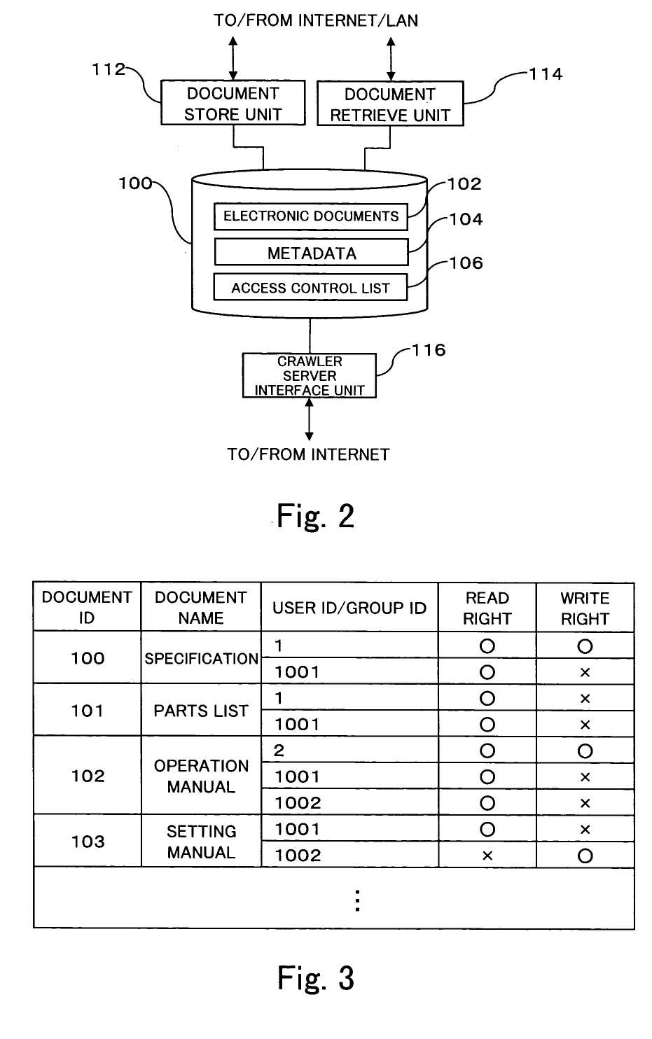

Referring to FIG. 2, details of the document server 10 will be described. The document server 10 has a document storage unit 100 for storing information of electronic documents administered by the document server 10. The document storage unit 100 stores files of electronic documents (a group of electronic documents 102), metadata for each of the electronic documents (a group of metadata 104), and an access control list 106 indicating access rights set for each of the electronic documents.

A document ID which is unique identification information is assigned to each electronic document. In FIG. 3, etc., for simplification purposes, the document ID is shown with a simple numerical value. However, it is also possible to create and use a document ID which is unique in the whole world using techniques such as universal unique ID (uuid).

Metadata is data indicating various information on the electronic document, and, particularly in this description, is information which is used during a search of electronic documents. For example, atypical example of metadata maybe one or more keywords or an abstract. For each electronic document, metadata for search is created and stored in the document storage unit 100.

The access control list 106 is a list indicating access rights of each user or each user group for the electronic documents.

FIG. 3 shows an example of data content in the access control list 106. In this illustrated example, the access control list 106 stores, for each electronic document stored in the document storage unit 100, a document ID assigned to the electronic document, the document name for the electronic document, and ID (identification information) of users to which an access right is given regarding the electronic document. In addition, the access control list 106 also records information indicating the content of access right given to the user, for each user to which an access right is given.

In this description, the “user” to which an ID is assigned includes not only an individual person, but also a group of people. The ID for identifying an individual person is called “user ID” and the ID for identifying a group is called “group ID”. In the example configuration of FIG. 3, the IDs “1” and “2” represent user IDs and IDs “1001” and “1002” represent group IDs. In the example structure of FIG. 3, as the content of the access right given to the user (or group), presence of “read” access right and presence of “write” access right for the electronic document are set. In the figure, a circle (o) represents a status in which an access is permitted and an X represents a status in which an access is not permitted. Therefore, in the example structure of FIG. 3, for an electronic document entitled “specification”, the user of ID “1” is permitted to both read and write, the group of ID “1001” is only permitted to read, and the other users and groups do not have any permission.

Information on an individual electronic document and access rights regarding the document is stored by a document store unit 112. The document store unit 112 accepts an instruction for a storing operation of an electronic document from a user PC 30 or 14 on the Internet 40 or on the LAN 12, assigns a document ID to the electronic document, and stores the electronic document in the document storage unit 100. The document store unit 112 also has a unit for setting metadata according to the stored electronic document. The metadata may be input by the user who stored the electronic document, or, alternatively, may be created by the document store unit 112 from the electronic document. It is also possible to combine these two methods. For example, metadata such as keywords and abstract may be automatically created using known tools.

The document store unit 112 has a function to accept setting of access rights to the stored electronic documents. In setting of the access rights, an ID of the users (individual or group) to which access is permitted and a content of the access rights to be given to the user (presence of permission for each of “read” access right and “write” access right) are designated for each electronic document. The access rights for the electronic document are set when the owner of the electronic document uploads the document to the document server 10. Afterwards, the access rights can be changed by a person having authority to change access rights such as the owner of the document and the administrator of the document server 10.

A document retrieve unit 114 is a unit for providing an electronic document stored in the document storage unit 100 to the user on the LAN 12 or on the Internet 40. The retrieve of the electronic document is performed by referring to the access control list 106 and is based on the scope of access rights given to the user regarding the electronic document. That is, the electronic document is provided while in a condition in which writing is prohibited to users who only have the read access right, and the electronic document is provided while in a condition in which writing is allowed to users who also have the write access right.

The document store unit 112 and document retrieve unit 114, upon reception of a request from a user for document storing or document retrieve, confirm authentication of the user using a password or the like to specify the user and accept the request within the scope of authority of the specified user. For example, the document store unit 112 and the document retrieve unit 114 would not accept a request for document storing or document retrieve by a user who is not registered in the document server 10, and, regarding the request for retrieve of document, only accept a request for retrieve of electronic document for which an access right is given to the user. Although not shown in the figures, the document server 10 has a database which stores authentication information of each user such as the ID and password, for user authentication.

A crawler server interface unit 116 is a unit for exchanging information with the crawler server 20, and has a function to provide information of the group of metadata 104 and of the access control list 106 in response to a request from the crawler server 20.

The document server 10 has been described. As the document server 10, for example, it is possible to use an existing file server such as Windows (registered trademark) 2000 Server available from Microsoft Corporation, with added functionality accommodating information collection operation of access rights from the crawler server 20.

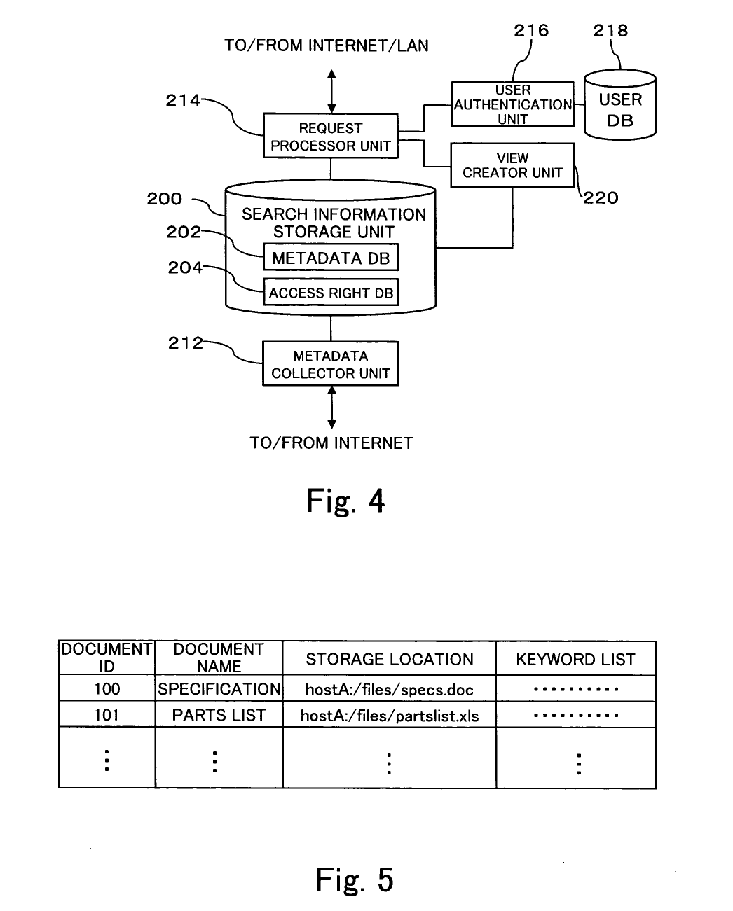

Next, referring to FIG. 4, details of the crawler server 20 will be described. The crawler server 20 has a search information storage unit 200 which is a storage device for storing information to be used in a document search service. The search information storage unit 200 has a metadata DB (database) 202 and an access right DB (database) 204.

The metadata DB202 is a database for storing a group of metadata for search, collected from the document servers 10. FIG. 5 shows an example of a data content stored in the metadata DB 202. In this example structure, the metadata DB 202 stores, for each electronic document, a document ID uniquely assigned to the document, the document name, information on a storage location of the document (for example, a combination of location information on the Internet of the document server which stores the document and path information indicating the location of the document within the server), and a keyword list set in the document (and/or extracted from the document). Here, a keyword list is exemplified as an example of metadata, but it is also possible to store other types of metadata (for example, abstract).

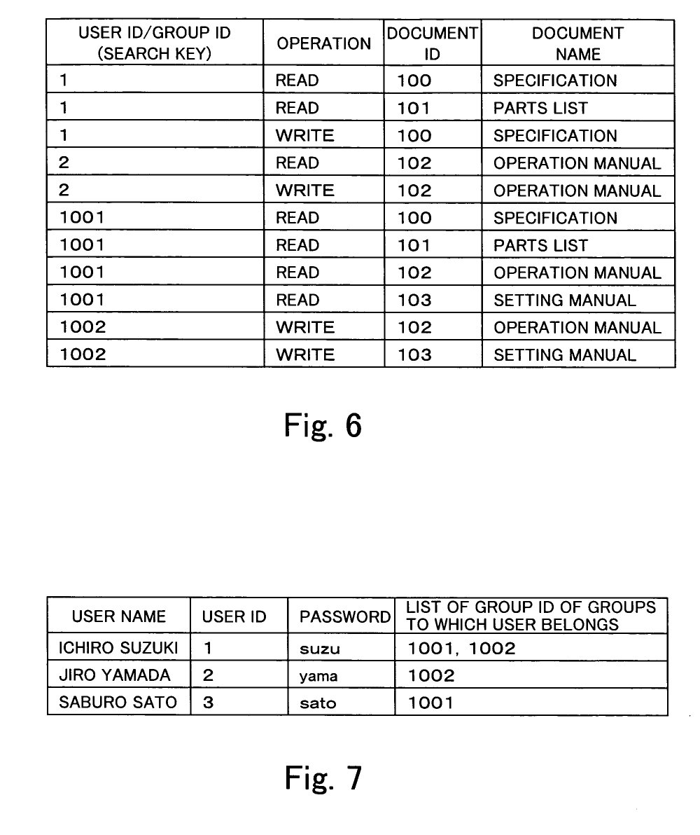

The access right DB 204 is a database storing access right information of each of the electronic documents collected from each of the document servers 10. FIG. 6 shows an example of a data content stored in the access right DB 204. In the access right DB 204 of FIG. 6, individual records of access right information are sorted by the value of the user ID/group ID in order to allow search by the user ID. The individual record includes the user ID/group ID, the operation, the document ID, and the document name. The “operation” is a code which indicates the operation permitted for the document indicated by the document ID within the record. The value of the item “operation” corresponds to the presence of “read access right” and “write access right” in the access control list 106. In order to facilitate search based on the document ID, it is also preferable to store, in the access right DB 204, a table of access right information sorted based on the document ID similar to the access control list 106 shown in FIG. 3.

A metadata collector unit 212 is a unit for collecting the group of metadata 104 and access control list 106 from each document server 10 and recording the collected information in the metadata DB 202 and access right DB 204. The metadata collector unit 212 can obtain these items of information via a network such as the Internet 40 using a network filing protocol in the known Windows (registered trademark) system or the like. It is also possible to configure such that only updated information is selectively obtained using a technique disclosed in, for example, Japanese Patent Laid-Open Publication No. 2001-184355.

A request processor unit 214 is a unit for accepting a request from a user PC 30 via the Internet 40 or via a LAN and providing information regarding a response from the server 20. The request processor unit 214 provides the information in a form of a web page, for example, such as a login page, search condition input page, and search result page.

A user authentication unit 216 is a unit for performing authentication of users who log in. The user information which forms the basis of the authentication is recorded in a user database (DB) 218. FIG. 7 shows an example of information recorded in the user DB 218. In this example configuration, the user DB 218 stores, for each user, the user name, the user ID, password for authentication, and a list of group IDs of groups to which the user belongs.

A view creator unit 220 creates information of a view in which a group of electronic documents which can be accessed by the user are shown in a hierarchy according to the type of access right. The type of access right in this description includes a classification based on assigned target indicating whether the access right is given to an individual or to a group and a classification based on type of permitted operation indicating whether the access right permits reading or permits writing. In the following description, an example configuration is shown in which classification based on both of these criteria is used. In the present embodiment, a hierarchical folder structure is created based on the type of access right and each electronic document is correlated to these folders as a member (the specifics will be described below). Information of such a folder structure is provided as view information.

Next, the processes performed by the crawler server 20 for a user request will be described.

The request processor unit 214, upon receiving a user ID and information of password input with respect to a login page from a user PC 30, transfers the user ID and password information to the user authentication unit 216 to perform user authentication. The user authentication unit 216 determines whether or not the combination of the user ID and the password is the correct combination referring to the user DB 218. When the user authentication unit 216 determines that the combination is a correct combination (that is, successful authentication), the user authentication unit 216 returns a list of group IDs of groups to which the user belongs and the name of the user to the request processor unit 214.

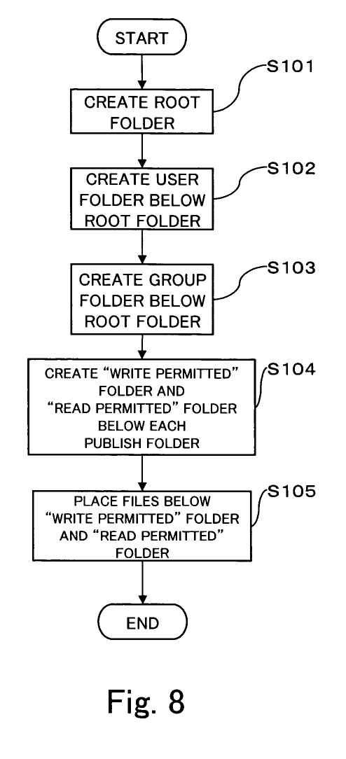

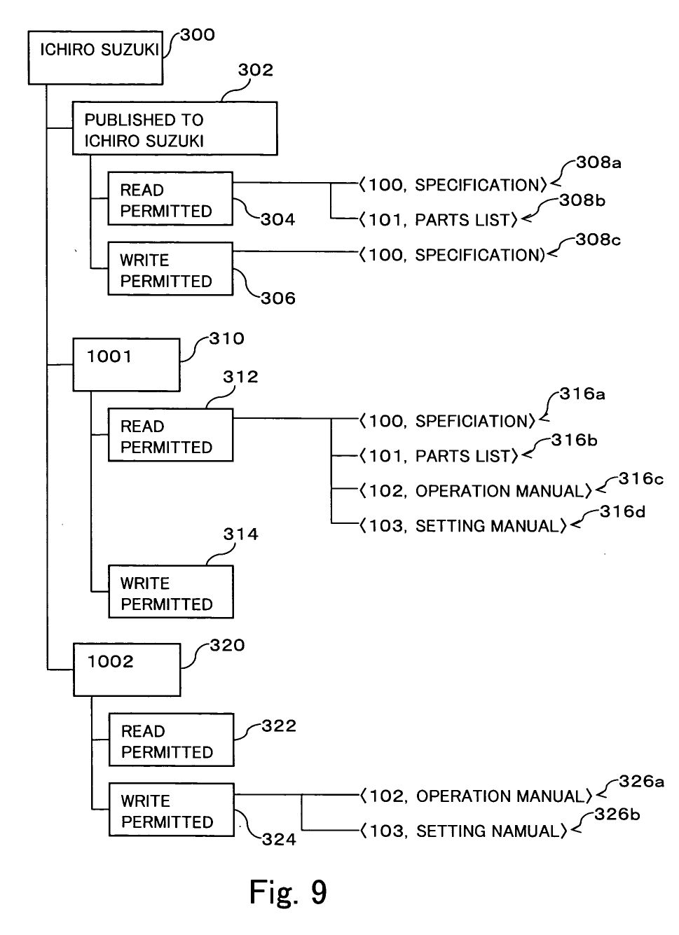

The request processor unit 214 provides the information received from the user authentication unit 216 along with the user ID of the user to a view creator unit 220 to request creation of a view. The view creator unit 220 receiving this request creates information of a folder structure as shown in, for example, FIG. 9 through a procedure such as the procedure shown in FIG. 8. FIG. 9 is an example of a folder structure created by the view creator unit 220 for “Ichiro Suzuki” of user ID “1”, which is created based on the access right DB of FIG. 6 and the user DB of FIG. 7. The procedure of FIG. 8 will now be described referring to the folder structure of FIG. 9.

In this procedure, first, a root folder 300 is created (step S101). The user name of the user is set as the folder name of the root folder 300. In a view screen, for an icon of each folder, the name of the folder is displayed in association with the folder. Next, a user folder 302 is created immediately below the root folder 300 (step S102). The user folder 302 is a folder for containing a group of electronic documents for which access rights are given to the individual user. The name of the user folder 302 is set as, for example, “published to XXX (the name of the user)”. Next, group folders 310 and 320 are created immediately below the root folder 300 (step S103). The group folders 310 and 320 are provided for each group to which the user belongs and contain a group of electronic documents for which access rights are given to the group. The group ID of the corresponding group is assigned as the folder name for the group folders 310 and 320. In the illustrated structure, because a person with the user ID of “1” belongs to a group “1001” and a group “1002” (refer to FIG. 7); two group folders 310 and 320 are created with the name of the folder being “1001” and “1002”. When a group nickname is set for the group, it is also possible to set the group nickname as the folder name in place of the group ID such as “1001”.

Next, “read permitted” folders 304, 312, and 322 and “write permitted” folders 306, 314, and 324 are created immediately below each of the user folder 302 and group folders 310 and 320 (step S104). The read permitted folders 304, 312, and 322 are folders storing a group of electronic documents for which a read operation is permitted to the user and the write permitted folders 306, 314, and 324 are folders storing a group of electronic documents for which a write operation is permitted to the user. A folder name, “read permitted”, is assigned to the read permitted folders 304, 312, and 322 and a folder name, “write permitted”, is assigned to the write permitted folders 306, 314, and 324.

Then, electronic documents 308a-308c, 316a-316d, and 326a and 326b are placed immediately below the created “read permitted” folders 304, 312, and 322 and write permitted folders 306, 314, and 324 (step S105). For placing electronic documents in the folders, electronic documents which satisfy the following conditions are searched referring to the access right DB 204:
(1) if the target folder is “read permitted”, the electronic documents having a value of “READ” in the “operation” column;
(2) if the target folder is “write permitted”, the electronic documents having a value of “WRITE” in the “operation” column;
(3) if the parent folder of the target folder is “published (to user)”, the electronic documents having a value of the user ID of the user in the “user ID/group ID” column; and
(4) if the parent folder of the target folder is “(group ID)”, the electronic documents having a value of the group ID in the “user ID/group ID” column.

For example, in the read permitted folder 304 below the “published to Ichiro Suzuki” folder 302, a document, “specification”, having a document ID of “100” and a document, “parts list”, having a document ID of “101” which have “READ” as the value for the “operation” column and the user ID of “1” which indicates “Ichiro Suzuki” as the value for the “user ID/group ID” column are placed.

In the illustrated example of FIG. 9, each of the electronic documents 308a-308c, 316a-316d, and 326a and 326b in the folders is shown with a pair of a document ID and a document name, <document ID, document name> and a view screen shows an icon in which such a text string is displayed. Each of these electronic documents 308a-308c, 316a-316d, and 326a and 326b is correlated through the document ID with metadata of each corresponding electronic document in the metadata DB 202. By using the information of storage location recorded in the corresponding metadata, it is possible to access the entity data of the electronic document existing on one of the document servers 10.

The request processor unit 214 provides, as the view information, the information of the folder structure thus created to the user PC 30 of the user who logs in. When the user PC 30 receives this information, the user PC 30 provides a view screen based on the information of the folder structure such as, for example, a view screen similar to a folder window provided by the Windows (registered trademark) operating system including, for example, a view screen in which files and folders below a folder are displayed in a list when the folder icon is clicked, a view screen in which the folder structure is displayed in a tree format, etc. It is also possible for the request processor unit 214 to create a webpage indicating these view screens and to provide the webpage to the user PC 30. In this configuration, for example, a URL for allowing an access to a webpage indicating another view screen in which the files and folders below a folder are displayed as a list is correlated with the icon of each of the folders on the view screen. By associating a URL indicating the storage location of the entity data of an electronic document to an icon of a file of an electronic document shown on the view screen, it is possible to allow a user to access the document by clicking on the icon. The document server 10 which is accessed performs user authentication as necessary, and, when authentication is successful, the document server 10 provides the electronic document to be accessed under the access authority permitted to the user.

The above-described view screen provided when the user logs in is a screen which shows a hierarchical folder structure of all electronic documents which can be accessed by the user based on the type of access rights. The crawler server 20, however, is not limited to such a configuration and may alternatively provide a view screen which shows a group of searched electronic documents in a hierarchical folder structure based on type of access rights in a similar manner. For this purpose, the request processor unit 214 is configured to receive search conditions such as a keyword from the user, search for electronic documents which satisfy the search conditions referring to the information in the metadata DB 202, and send the information of the document ID or the like of the searched electronic documents to the view creator unit 220. The view creator unit 220 executes a process similar to creation of a view during login as described above, with the target of the process being the received group of electronic documents (instead of all of the electronic documents in the view creation at login). With this configuration, it is possible to provide, to a user, a hierarchical view screen for search results based on type of access rights.

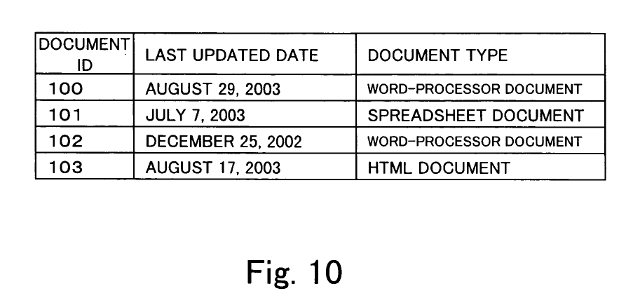

Next, an alternative embodiment of the present invention will be described referring to FIGS. 10-12.

A basic system structure of this embodiment is similar to the embodiment shown in FIGS. 1, 2, and 4. A characteristic of this embodiment is that the crawler server 20 further collects information on document properties such as the last updated date/time of the electronic document and the type of document and provides a view showing a folder structure considering the document properties in addition to the type of the access rights.

FIG. 10 shows an example of a document property table stored in a search information storage unit 200 of a crawler server 20. The document property table stores, for each electronic document, a document ID, last updated date/time, and document type. The “last updated date/time” in this description refers to date/time when the electronic document is newly created or the contents are updated after the document has been created. In general, an operating system manages the last updated date/time of a file and the document server 10 also manages the last updated date/time of each electronic document. Therefore, the crawler server 20 collects information on the last updated date/time of each electronic document from the document servers 10 and records the information in the document property table. The document type indicates the type of electronic document itself such as, for example, “word-processor document”, “spreadsheet document”, and “HTML document”. The document type may alternatively be viewed as a type of application for processing the electronic document. In general, an operating system manages a type of a file (type of corresponding application) with an extension of the file name or other information, and the document server 10 also manages the type of each electronic document in a similar manner. The crawler server 20 collects information on the document type of the electronic documents from the document servers 10 and records these items of information in the document property table.

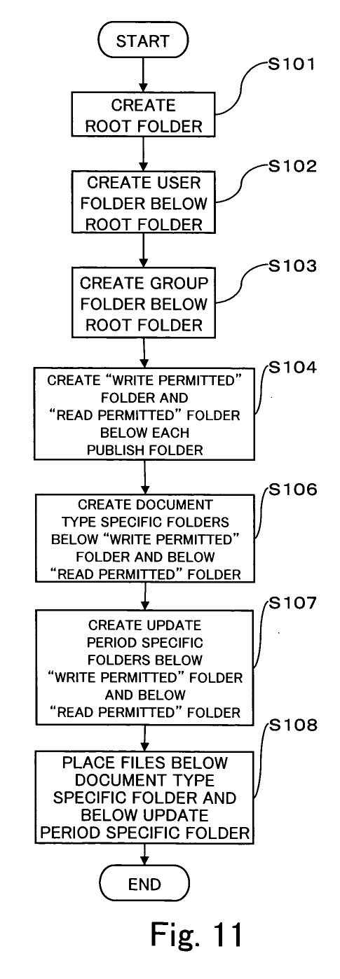

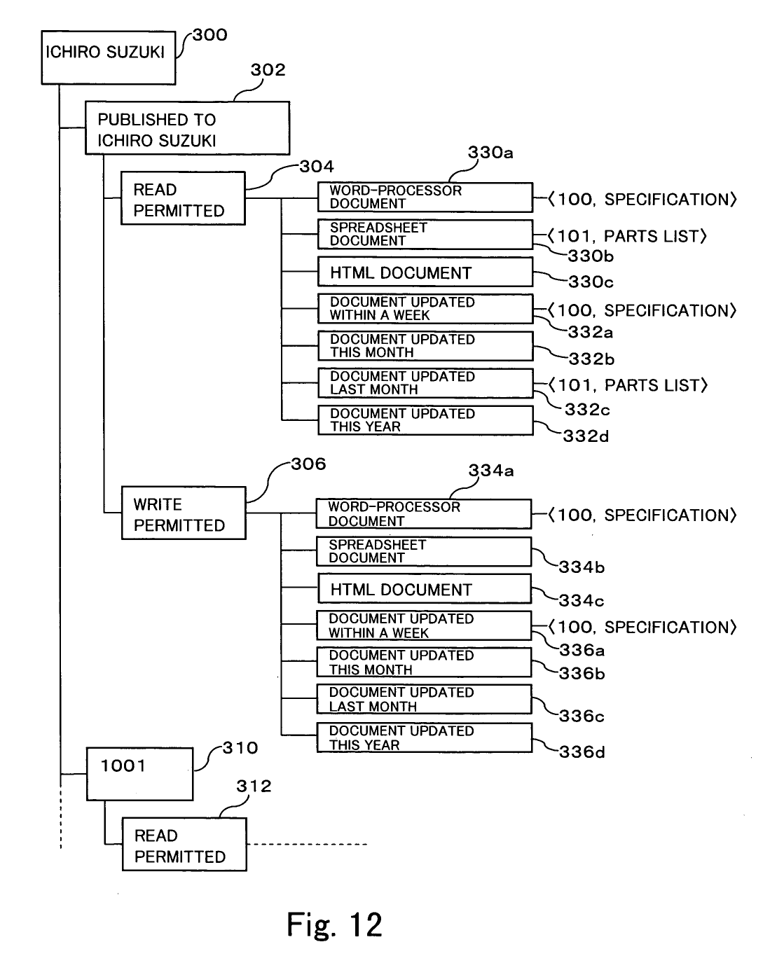

Next, a process for the view creator unit 220 to create a view using the document property table and the access right DB 204 will be described referring to FIGS. 11 and 12. FIG. 11 is a flowchart showing the process procedure and FIG. 12 is a folder structure of a view created for a user, “Ichiro Suzuki”, based on the access right DB of FIG. 6, the user DB of FIG. 7, and the document property table of FIG. 10.

This procedure of creating the view is identical to the process of creating the view in the above-described embodiment until step S104 (refer to FIG. 8). In this embodiment, after read permitted folders 304, 312, etc. and write permitted folders 306, etc. are created in step S104 under the folders 302, 310, etc. which are published to a user or to a group, document type specific folders 330a-330c and 334a-334c and update period specific folders 332a-332d and 336a-336d are created below the read permitted folders and below the write permitted folders (steps S106 and S107). In the illustrated structure of FIG. 12, three types of folders including “word-processor document”, “spreadsheet document”, and “HTML document” are shown as the document type specific folders. A name of the document type (for example, “word-processor document”) is assigned to the document type specific folder as the folder name. The update period specific folders are provided for a number of update periods such as “documents updated within a week”, “documents updated this month”, “documents updated last month”, and “documents updated this year” and a folder name indicating the content of the update period is assigned.

After the document type specific folders and update period specific folders are created in this manner, electronic documents are placed immediately below the created document type specific folders and update period specific folders (S108). First, in the placement process of electronic documents with respect to the document type specific folders, electronic documents are searched from the access right DB 204 which satisfy the following condition:
(1) electronic documents having the document type which is identical to the name of the target folder;
(2) if the parent folder of the target folder is “read permitted”, electronic document having “READ” in the “operation” column;
(3) if the parent folder of the target folder is “write permitted”, electronic documents having “WRITE” in the “operation” column;
(4) if the parent folder of the parent folder of the target folder is “published to (user)”, electronic documents having the user ID of the user in the “user ID/group ID” column; and
(5) if the parent folder of the parent folder of the target folder is “(group ID)”, electronic documents having the group ID in the “user ID/group ID” column.

In the placement process of electronic documents to the update period specific folders, electronic documents which satisfy the following conditions are searched in the access right DB 204:
(1) if the target folder is “updated within a week”, electronic documents having the date indicated in the “last updated date/time” column which is later than a week before the current date;
(2) if the target folder is “updated this month”, electronic documents having the month in the date indicated in the “last updated date/time” column equal to the current month;
(3) if the target folder is “updated last month”, electronic documents having the month in the date indicated in the “last updated date/time” column equal to the month of the date which is one month before the current date;
(4) if the target folder is “updated this year”, electronic documents having the year in the date indicated in the “last updated date/time” column equal to the current year;
(5) if the parent folder of the target folder is “read permitted”, electronic documents having “READ” in the “operation” column;
(6) if the parent folder of the target folder is “write permitted”, electronic documents having “WRITE” in the “operation” column;
(7) if the parent folder of the parent folder of the target folder is “published to (user)”, electronic documents having the user ID received from the user authentication unit in the “user ID/group ID” column; and
(8) if the parent folder of the parent folder of the target folder is “(group ID)”, electronic documents having the group ID in the “user ID/group ID” column.

For example, in the update period specific folder, “updated within a week”, 336a below the write permitted folder 306 below the “published to Ichiro Suzuki” folder 302, the document, “specification” of document ID “100” having the value of the “last updated date/time” column in the document property table being a data later than a week before the current date, a value of the “operation” column being “WRITE”, and the value of the “user ID/group ID” column being the user ID “1” which represents “Ichiro Suzuki” is placed.

Embodiments of the present invention have been described. As described, in the present embodiment, the crawler server 20 collects access right information from the document servers 10 and provides, to a user, information of electronic documents which can be accessed by the user based on the access right information. Because of this, the complexity for placing individual electronic documents in a folder for each user can be reduced. In addition, because it is possible to set a group made of plural users and to set access rights for the group regarding electronic documents, it is possible to reduce cost to individually set access rights for an individual user.

In addition, in the present embodiment, because the crawler server 20 only collects metadata and access right information (and document property information in the alternative embodiment) from the document servers 10 and does not collect the electronic document itself, the possibility of leaking out information of the electronic document itself to the administrator of the crawler server 20 is decreased. Instead of creating the metadata in the document servers 10, it is also possible to alternatively configure the structure such that the crawler server 20 collects electronic documents from the document servers 10 and creates metadata. In this configuration, in order to reduce the possibility of out the electronic document, it is possible to configure such that the crawler server 20 discards the electronic document itself after the metadata is created.

In the present embodiment, because a view is provided to a user in which a group of electronic documents which can be accessed by the user are indicated classified by the type of access rights, it is possible for the user to quickly reach the target document using the view. For example, when a user wishes to view a document related to a project which involves a group to which the user belongs, the user can search for the document below the folder of the group in the view. In addition, because, in the alternative embodiment, a view can be provided in which classifications by document property such as the document type and last updated date/time are incorporated, it is possible to quickly identify the target document by following the folder hierarchy of the view.

In the above-described embodiments, the folder structure of the view has a hierarchical structure in the order of folders for each publish destination (destined to individual user or each group to which the user belongs), folders for each permitted operation (read permitted/write permitted), and document type/update period specific folders. This structure, however, is only exemplary, and the order of hierarchy may be changed or may be customized by the user based on the user's preferences, or a customized order of hierarchy may be set to the system of the present embodiment.

In the above-described configuration, as the viewpoint for classifying types of access rights for defining the folder structure of the view, a viewpoint of the target to which the access right is to be given and a viewpoint of permitted operation are exemplified. The viewpoint, however, is not limited to these viewpoints, and other viewpoints may be used such as, for example, a viewpoint of the date/time and the period in which the access right is set. This viewpoint is for a configuration when a date of expiration (date in which the access right expires) or a term of validity is set to the access right such as, for example, “(write permitted) until a certain day in a certain month”. In the illustrated configuration of FIG. 9, in this viewpoint, for example, folders such as “valid until today”, “expire within a period of a day to a week from today”, “expire within a period of a week to a month from today”, “expire after a month from today”, and “no expiration date” folders are created below the read permitted folder 304, etc. and below the write permitted folder 306, etc. and electronic documents are placed in the folders corresponding to the expiration date and/or the term of validity. In this configuration, the documents are classified from the viewpoint of the expiration date/time of the access rights, but it is also possible to create folders in which documents are classified based on the effective date/time of the access rights (such as, for example, a folder of “becomes effective within a week”, etc.). In addition to the viewpoint for classification based on the date/time, it is also possible to create folders in which dates such as the expiration and effective dates are classified by the day of the week (such as, for example, “until Wednesday”, “until Thursday”, etc.) and to classify the electronic documents into these folders. It is also possible to create folders based on a classification which is more detailed than the date such as, for example, time of the day (for example, folders such as “expires within an hour”, “expires before noon”, etc.).

The entire disclosure of Japanese Patent Application No. 2004-050311 filed on Feb. 25, 2004 including specification, claims, drawings, and abstract is incorporated herein by reference in its entirety.

1. A computer program product embodied on one or more computer readable media, for providing, to a user on a network, view information indicating information of a plurality of electronic documents on the network, the computer program product comprising:
computer readable program code means for collecting, from each document server existing on the network, access right information indicating an access right given to each user for each electronic document stored in the document server and for constructing an access right database; and
computer readable program code means for creating, in response to a request from a user, view information in which electronic documents for which an access right is given to the user is indicated classified based on the type of access right referring to the access right database and for providing the view information to the user.

2. A computer program product according to claim 1, wherein:
the computer readable program code means for creating view information and providing the view information to a user comprises computer readable program code means for creating view information indicating a folder structure in which electronic documents corresponding to a type of access right given to the requesting user are placed in a folder for each corresponding type of access right.

3. A computer program product according to claim 2, wherein
a plurality of types of access right exist for each of a plurality of viewpoints; and
the computer readable program code means for creating view information and providing the view information to a user places a group of folders for types of access right regarding the same viewpoint in one hierarchical level, creates a hierarchical folder structure having a tree form in which the hierarchical levels of the viewpoints are placed according to a predetermined order defined among the plurality of viewpoints, and creates a folder structure in which electronic documents are placed in the deepest folder in the folder structure, the electronic documents satisfying all types of access right corresponding to the folder and all ancestor folders.

4. A computer program product according to claim 1, wherein
the computer program product further comprises computer readable program code means for collecting, from each document server existing on the network, document property information of each electronic document stored in the document server and for constructing a document property table, and
the computer readable program code means for creating view information and providing the view information to user comprises computer readable program code means for creating view information, referring to the access right database and the document property table, in which a group of electronic documents for which an access right is given to the user is classified based on the type of the access right and based on the document property information.

5. A document view providing device for providing, to a user on a network, view information indicating information of a plurality of electronic documents on the network, the document view providing device comprising:
an access right information collector unit for collecting, from each document server existing on the network, access right information indicating an access right given to each user for each electronic document stored in the document server and for constructing an access right database, and
a view provider unit for creating, in response to a request from a user, view information in which electronic documents for which an access right is given to the user is indicated classified based on the type of access right referring to the access right database and for providing the view information to the user.

6. A document view providing device according to claim 5, wherein
the view provider unit creates view information indicating a folder structure in which electronic documents corresponding to a type of access right given to the requesting user are placed in a folder for each corresponding type of access right.

7. A document view providing device according to claim 6, wherein
a plurality of types of access right exist for each of a plurality of viewpoints, and
the view provider unit places a group of folders for types of access rights regarding the same viewpoint in one hierarchical level, creates a hierarchical folder structure having a tree form in which the hierarchical levels of the viewpoints are placed according to a predetermined order defined among the plurality of viewpoints, and creates a folder structure in which electronic documents are placed in the deepest folder in the folder structure, the electronic documents satisfying all types of access right corresponding to the folder and all ancestor folders.

8. A document view providing device according to claim 5, further comprising a property information collector unit for collecting, from each document server existing on the network, document property information of each electronic document stored in the document server and for constructing a document property table, and
wherein the view provider unit creates view information, referring to the access right database and the document property table, in which a group of electronic documents for which an access right is given to the user is classified based on the type of access right and based on the document property information.

9. A document distribution system for providing, to a user on a network, view information indicating information of a plurality of electronic documents on the network, the document distribution system comprising:
one or more document servers provided on the network for storing an electronic document and providing the electronic document in response to a request from a user; and
a document view providing device provided on the network for providing, to a user, view information indicating electronic documents which can be accessed by the user from among the electronic documents stored in the one or more document servers, wherein
the document server comprises an access right information storage unit for storing access right information indicating an access right given to each user for each electronic document which is stored in the document server, and
the document view providing device comprises:
an access right information collector unit for collecting access right information stored in the access right information storage unit of the document server and for constructing an access right database, and
a view provider unit for creating, in response to a request from a user, view information in which electronic documents for which an access right is given to the user is indicated classified based on the type of access right referring to the access right database and for proving the view information to the user.

10. A document distribution system according to claim 9, wherein
the view provider unit creates view information indicating a folder structure in which electronic documents corresponding to a type of access right given to the requesting user are placed in the folder for each corresponding type of access right.

11. A document distribution system according to claim 10, wherein
a plurality of types of access right exist for each of a plurality of viewpoints, and
the view provider unit places a group of folders for types of access rights regarding the same viewpoint in one hierarchical level, creates a hierarchical folder structure having a tree form in which the hierarchical levels of the viewpoints are placed according to a predetermined order defined among the plurality of viewpoints, and creates a folder structure in which electronic documents are placed in the deepest folder in the folder structure, the electronic documents satisfying all types of access right corresponding to the folder and all ancestor folders.

12. A document distribution system according to claim 9, wherein
the document view providing device further comprises a property information collector unit for collecting, from each document server existing on the network, document property information of each electronic document stored in the document server and for constructing a document property table, and
the view provider unit creates view information, referring to the access right database and the document property table, in which a group of electronic documents for which an access right is given to the user is classified based on the type of access right and based on the document property information.

13. A computer-implemented method for a computer connected to a network to provide, to a user on the network, view information indicating information of a plurality of electronic documents on the network, the computer-implemented method comprising:
a step, performed by the computer, of collecting, from each document server existing on the network, access right information indicating an access right given to each user for each electronic document stored in the document server and of constructing an access right database, and
a step, performed by the computer, of creating, in response to a request from a user, view information in which electronic documents for which an access right is given to the user is indicated classified based on the type of access right referring to the access right database and of providing the view information to the user.

14. A computer-implemented method according to claim 13, wherein
the step of creating view information and providing the view information to user comprises a sub step of creating view information indicating a folder structure in which electronic documents corresponding to a type of access right given to the requesting user are placed in the folder for each corresponding type of access right.

15. A computer-implemented method according to claim 14, wherein
a plurality of types of access right exist for each of a plurality of viewpoints, and
the step of creating view information and providing the view information to user comprises a sub step of placing a group of folders for types of access right regarding the same viewpoint in one hierarchical level, creating a hierarchical folder structure having a tree form in which the hierarchical levels of the viewpoints are placed in a predetermined order defined among the plurality of viewpoints, and creating a folder structure in which electronic documents are placed in the deepest folder in the folder structure, the electronic documents satisfying all types of access right corresponding to the folder and all ancestor folders.

16. A computer-implemented method according to claim 13, further comprising a step of:
collecting, from each document server existing on the network, document property information of each electronic document stored in the document server and for constructing a document property table, wherein
the step of creating view information and providing the view information to user comprises a sub step of creating view information, referring to the access right database and the document property table, in which a group of electronic documents for which an access right is given to the user is classified based on the type of access right and based on the document property information.
